(19) United States
(12) Patent Application Publication
(10) Pub. No.: US 2018/0316497 A1
(43) Pub. Date: Nov. 1, 2018

(54) SECURITY APPARATUS AND CONTROL METHOD

(71) Applicant: FUJITSU LIMITED, Kawasaki-shi (JP)

(72) Inventor: Kiyoshi Kohiyama, Toshima (JP)

(73) Assignee: FUJITSU LIMITED, Kawasaki-shi (JP)

(21) Appl. No.: 16/029,800

(22) Filed: Jul. 9, 2018

Related U.S. Application Data
(63) Continuation of application No. PCT/JP2016/051188, filed on Jan. 15, 2016.

(51) Int. Cl. H04L 9/08; H04L 29/06

(52) U.S. Cl. CPC H04L 9/0861; H04L 9/0894; H04L 63/0869

(57) ABSTRACT

A security apparatus includes: a memory provided in a secure region and configured to store a plurality of programs which preforms respective security processes with an external apparatus in accordance with respective security methods, and security information which is used for the security processes; and a processor configured to: execute a first program among the plurality of programs; perform a first security process with a first external apparatus; acquire first secret information from the first external apparatus; execute a second program different from the first program among the plurality of programs; perform a second security process with a second external apparatus; and convert the first secret information into second secret information to be transmitted to the second external apparatus.

### CROSS-REFERENCE TO RELATED APPLICATION

This application is a continuation application of International Application PCT/JP2016/051188 filed on Jan. 15, 2016 and designated the U.S., the entire contents of which are incorporated herein by reference.

### FIELD

The embodiments relates to a security apparatus and the like.

### BACKGROUND

A related technique is disclosed in International Publication Pamphlet No. WO 2014/049830.

### SUMMARY

According to one aspect of the embodiments, a security apparatus includes: a memory provided in a secure region and configured to store a plurality of programs which preforms respective security processes with an external apparatus in accordance with respective security methods, and security information which is used for the security processes; and a processor configured to: execute a first program among the plurality of programs; perform a first security process with a first external apparatus; acquire first secret information from the first external apparatus; execute a second program different from the first program among the plurality of programs; perform a second security process with a second external apparatus; and convert the first secret information into second secret information to be transmitted to the second external apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network system according to the present embodiment.

FIG. 2 is a functional block diagram illustrating a configuration of a terminal apparatus according to the present embodiment.

FIG. 3 is a flowchart illustrating an example of a DRM process performed by a CPU in a secure region.

FIG. 4 is a flowchart illustrating an example of a DTCP-IP process performed by the CPU in the secure region.

FIG. 5 is a flowchart illustrating a process procedure in a case where the secure region receives a content watching request.

FIG. 6 is a flowchart illustrating a process procedure in a case where a request for performance information is received.

FIG. 7 is a diagram illustrating an example of an IoT network system.

FIG. 8 is a functional block diagram illustrating a configuration of a terminal apparatus.

FIG. 9 is a diagram illustrating an example of a protocol stack.

FIG. 10 is a diagram illustrating an example in which the terminal apparatus securely transmits the content via a home network.

### DESCRIPTION OF EMBODIMENTS

In recent years, a system has been devised in which various pieces of information are accumulated in a server by using an Internet of Things (IoT) apparatus having a communication function, a sensor function, a processor function, and the like, and an added value is produced by analyzing the accumulated data.

For example, an IoT apparatus is mounted on a vehicle, position information of the vehicle is collected by the IoT apparatus and is analyzed, and thus traffic jam information can be distributed. An IoT apparatus is mounted on a health appliance, the number of steps, blood pressure, a body temperature, and the like of a user are collected and analyzed, and thus a probability that the user may get sick can be calculated by comparing the health conditions of people living in a certain place with the health conditions of the user. An IoT apparatus is mounted on a home server, the home server collects and analyzes video information watched by a user, and thus watching tendencies on an age basis, a sex basis, and a resident basis can be understood.

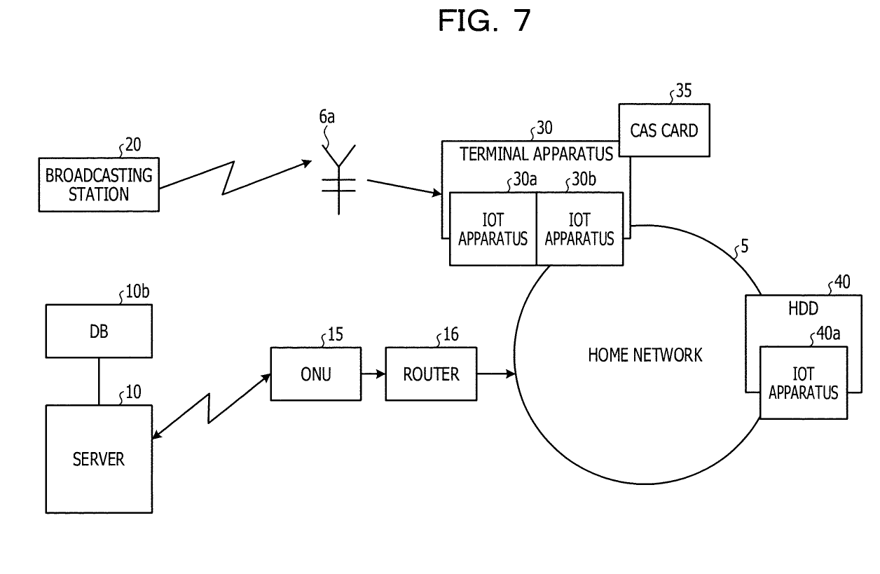

Here, there are various coupling forms in an IoT network system in which each IoT apparatus is connected to a server. FIG. 7 is a diagram illustrating an example of an IoT network system. As illustrated in FIG. 7, the IoT network system includes a server 10, an optical network unit (ONU) 15, a router 16, a broadcasting station 20, a terminal apparatus 30, and a hard disk drive (HDD) 40.

The server 10 is connected to a database (DB) 10b. A conditional access systems (CAS) card 35 is inserted into the terminal apparatus 30 which has IoT apparatuses 30a and 30b. The HDD 40 has an IoT apparatus 40a. The terminal apparatus 30 receives electric waves from the broadcasting station via an antenna 6a. The terminal apparatus 30 is connected to the router 16 and the HDD 40 via a home network 5.

In the IoT network system illustrated in FIG. 7, the terminal apparatus 30 is connected to two networks. One of the two networks is a broadcast network, and the terminal apparatus 30 receives a video program from the broadcasting station 20 via broadcast radio waves and the antenna 6a. The other of the two networks is an Internet network, and the terminal apparatus 30 transmits and receives data to and from the server 10 via an optical network, the ONU 15, the router 16, and the home network 5. The home network 5 is an example of an Ethernet (registered trademark) network.

A user of the terminal apparatus 30 may watch video information via the broadcast network or the Internet. The user of the terminal apparatus 30 may accumulate the video information in the HDD 40, and may thus watch the video information at the user's favorite timing.

For example, the IoT apparatuses 30a and 30b of the terminal apparatus 30 transmit watching information, personal information, and the like to the server 10 via the Internet. The personal information includes the age, the sex, and an address of the user. The server 10 accumulates, in the DB 10b, the watching information, the personal information, and the like from the IoT apparatuses 30a and 30b of the terminal apparatus 30 and other IoT apparatuses, and understands watching tendencies on an age basis, a sex basis, and a resident basis by analyzing the watching information, the personal information, and the like accumulated in the DB 10b. Although not described here, the server 10 may collect various pieces of information from the IoT apparatuses and thus calculate traffic jam information or a probability of getting sick as described above.

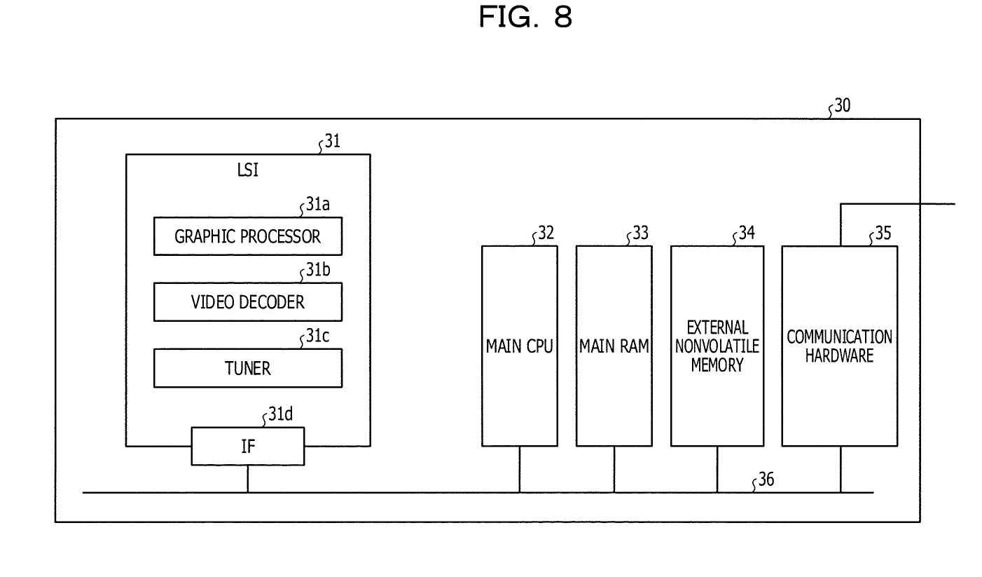

FIG. 8 is a functional block diagram illustrating a configuration of the terminal apparatus. As illustrated in FIG. 8, the terminal apparatus 30 includes a large-scale integration (LSI) 31, a main central processing unit (CPU) 32, a main random access memory (RAM) 33, an external nonvolatile memory 34, and communication hardware 35. The respective devices 31 to 35 are connected to a bus 36. The LSI includes a graphic processor 31a, a video decoder 31b, and a tuner 31c, and is connected to the bus 36 via an IF 31d. As illustrated in FIG. 8, the LSI 31 of the terminal apparatus 30 does not include the main CPU 32, and exchanges data via the bus 36. In the terminal apparatus 30, the main CPU 32 reads a program to the main RAM 33 to perform a process which will be described later.

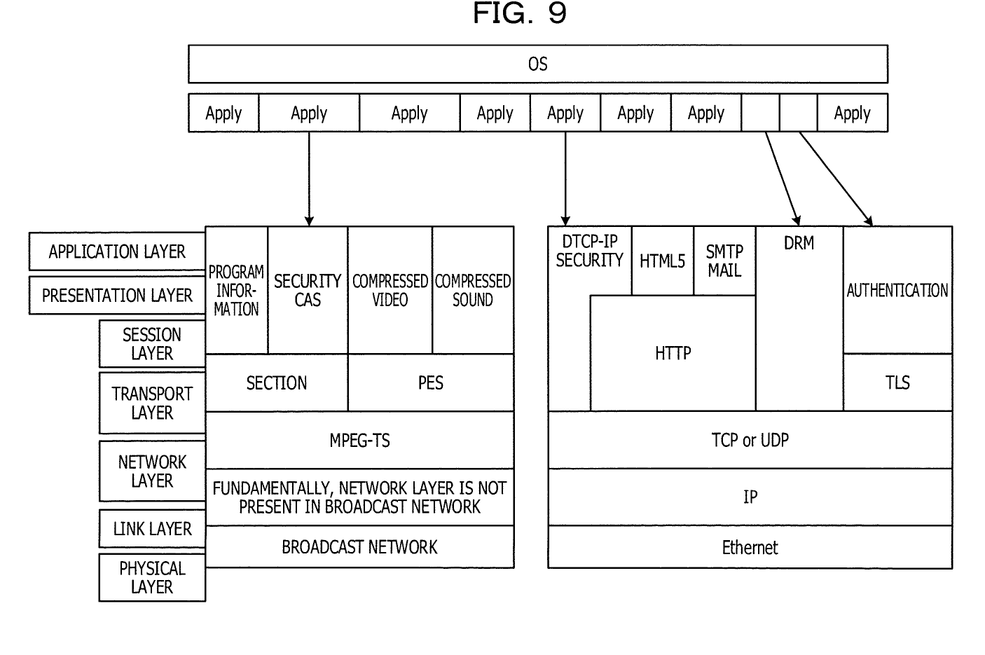

For example, a predetermined protocol stack is implemented in the terminal apparatus 30. FIG. 9 is a diagram illustrating an example of a protocol stack. As illustrated in FIG. 9, the protocol stack may be generally divided into a physical layer, a link layer, a network layer, a transport layer, a session layer, a presentation layer, and an application layer. Each layer is not very strictly applied, and boundaries between the respective layers are ambiguous.

For example, a broadcast-network-related protocol stack includes a broadcast network layer, a Moving Picture Experts Group (MPEG)-Transport Stream (TS) layer, a section layer, a PES layer, a program information layer, a CAS layer, a compressed video layer, and a compressed audio layer. A layer corresponding to a network layer is not inherently present in the broadcast-network-related protocol stack.

For example, an Internet-network-related protocol stack includes an Ethernet layer, an Internet Protocol (IP) layer, and a Transmission Control Protocol (TCP) layer or a User Datagram Protocol (UDP) layer. The Internet-network-related protocol stack includes a HyperText Transfer Protocol (HTTP) layer, a Digital transmission Content Protection (DTCP)-IP security layer, and a HyperText Markup Language (HTML) 5 layer. The Internet-network-related protocol stack includes a Simple Mail Transfer Protocol (SMTP) mail layer, a Digital Rights Management (DRM) layer, and a Transport Layer Security (TLS) layer.

When the same protocol is used between the respective devices, information can be transmitted and received between the respective layers. For example, the Ethernet layer is shared between the HDD 40 and the terminal apparatus 30 illustrated in FIG. 7, and thus information in the physical layer and the link layer can be shared therebetween.

The broadcast-network-related protocol stack will be described. In the broadcast network layer, a signal from the broadcast network is selected as channel information by the tuner. In the MPEG-TS layer, the selected channel information is converted into a digital packet format with a fixed length of 188 bytes and is output. There is an identification number in a leading portion of each packet, and video information, audio information, or program information can be identified by referring to the identification number. A variety of time division multiplexing transmissions can be performed by using identifiers.

The section layer has a function of transmitting information. In the section layer, a process is performed in which information such as a program name of a video included in a stream, an actor name, and a synopsis of the program is extracted from an audio stream or a video stream. In the section layer, CAS related information is handled. The CAS related information includes key information which is used in a case of decrypting an encrypted MPEG compressed video stream or an encrypted compressed audio stream, in an encrypted state.

The PES layer has a function of transmitting an audio stream or a video stream. MPEG compressed videos and MPEG compressed sounds are present in a stream transmitted in the PES layer.

A master key for decrypting the encrypted key information is held in the CAS card 35 illustrated in FIG. 7. If the encrypted key information is transmitted to the CAS card 35 in the security CAS layer, the CAS card 35 decrypts the key information by using the master key. The program information layer performs various processes by using program information. The program information includes information such as a program name, an actor name, and a synopsis of the program. The compressed video layer performs a process of decrypting an encrypted MPEG compressed video stream. The compressed audio layer performs a process of decrypting an encrypted compressed audio stream.

Various application programs (Apply) operating on an operating system (OS) of the terminal apparatus 30, illustrated in FIG. 9, control processes performed by the respective layers. The application programs perform selection of a channel in the tuner and extraction of each element of the MPEG-TS in which a sound, a video, or the like output from the tuner is time-divided. Each element of the MPEG-TS includes a sound, a video, program information, and CAS related information. The application programs transmit the encrypted key information to the CAS card 35, and acquires decrypted key information. The application programs decrypt a video or a sound by using the key information, and controls a decompression process for an MPEG compressed video or sound. The application programs extract program information, and displays information regarding a program on a monitor of the terminal apparatus 30.

Next, the Internet related protocol stack will be described. In the Internet related protocol stack, the Ethernet layer is present in the physical layer and the data link layer. The IP layer is present on the Ethernet layer. The IP layer is divided into the UDP layer and the TCP layer. The HTTP layer is present on the UDP/TCP layer, and a specific application layer is present on the HTTP layer. For example, an Internet browser application program of the HTML5 layer or the like operates by using the HTTP layer. The SMPT mail layer is present on the HTML5 layer, and various mail application programs operate. The TLS layer performs an authentication process on each terminal apparatus on the Internet. The HTTP layer, the HTML5 layer, and the SMTP mail layers are layers performing processes regarding security.

The DTCP-IP security layer, the DRM layer, the authentication layer, and the TLS layer are layers performing processes regarding security.

The DRM layer is a layer for performing secure transmission and reception of a content key for encrypted Internet content between the server 10 and the terminal apparatus 30. The DRM layer performs an authentication process using a public key and a secret key between the terminal apparatus 30 and the server 10. The DRM layer performs a process of generating a temporary key called a session key using a random number generator and a process of sharing the temporary key. The DRM layer performs transmission and reception of encrypted data using the session key. In the process in the DRM layer, generally, a content key encrypted with the session key is received by the terminal apparatus 30 from the server 10, and the content key is decrypted on the terminal apparatus 30 side. Thereafter, the terminal apparatus 30 decrypts the encrypted content information with the content key. The DRM layer is used in a case where content information is shared in a secure manner.

The TLS layer is a representative protocol for performing mutual authentication between the server 10 and the terminal apparatus 30. The TLS layer performs an authentication process using a public key and a secret key between the terminal apparatus 30 and the server 10. The TLS layer performs a process of generating a temporary key called a session key using a random number generator and a process of sharing the temporary key. The TLS layer performs transmission and reception of encrypted data using the session key. The TLS layer is normally used in a case where general information such as personal information is securely transmitted and received.

The DTCP-IP security layer is used in a case where content information is securely transmitted and received via the home network 5. Herein, as an example, a description will be made of a case where the terminal apparatus 30 securely transmits content information to the HDD 40 via the home network 5.

The DTCP-IP security layer performs an authentication process using a public key and a secret key between the terminal apparatus 30 and the HDD 40 by using the TCP layer. The DTCP-IP security layer performs a process of generating a temporary key called a session key using a random number generator and a process of sharing the temporary key. The DTCP-IP security layer generates a content key based on the session key. The DTCP-IP security layer performs transmission and reception of the content encrypted with the content key in the HTTP layer. The HDD 40 decrypts the encrypted content information received from the HTTP layer, re-encrypts the content information with another key, and accumulates the content information.

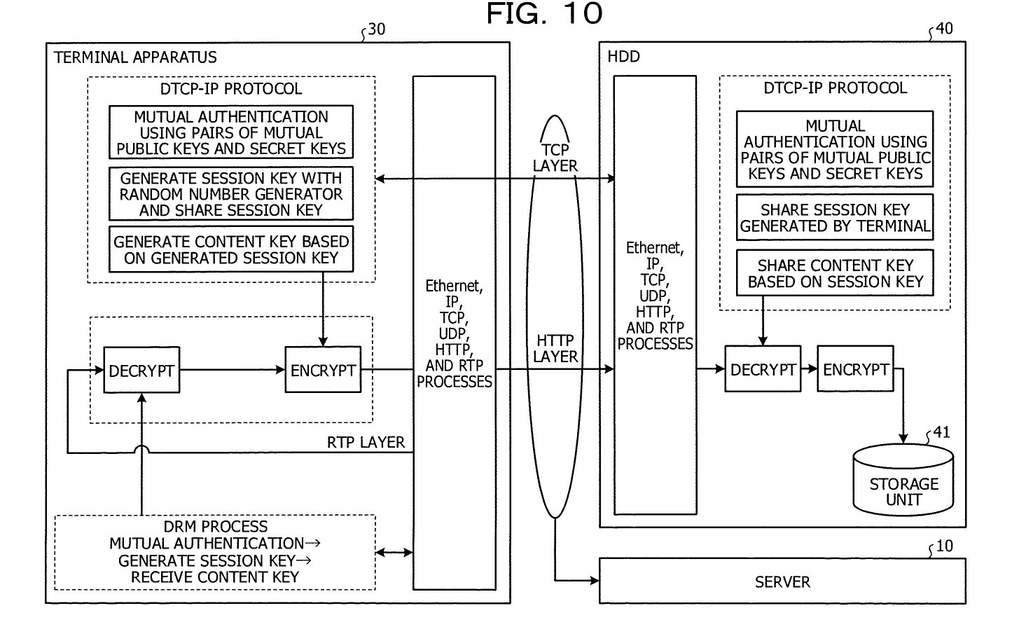

FIG. 10 is a diagram illustrating an example in which the terminal apparatus securely transmits the content via the home network. In the example illustrated in FIG. 10, the terminal apparatus 30 receives encrypted content information from the server 10 via the Internet network. The terminal apparatus 30 decrypts the content information with a decryption key, re-encrypts the content information with an encryption key, and transmits the encrypted content information to the HDD 40 via the home network 5. The HDD 40 decrypts the content information, re-encrypts the decrypted content information with an encryption key, and accumulates the encrypted content information in a storage unit 41.

The terminal apparatus 30 performs a DRM process according to a protocol defined in the DRM layer. As the DRM process, the terminal apparatus 30 sequentially performs mutual authentication, generation of a session key, and reception of a content key. The terminal apparatus 30 receives the encrypted content information from the server 10, and decrypts the received content information. The terminal apparatus 30 re-encrypts the decrypted content information for the home network 5. The terminal apparatus 30 generates an encryption key used for encryption in accordance with a protocol defined in the DTCP-IP security layer.

The terminal apparatus 30 performs mutual authentication using a pair of a public key and a secret key with the HDD 40. The terminal apparatus 30 generates a session key by using the random number generator of the terminal apparatus 30, and shares the session key with the HDD 40. The terminal apparatus 30 re-encrypts the content information with a content key, and transmits the re-encrypted content information to the HDD 40 in the HTTP layer.

The HDD 40 receives the re-encrypted content information. The HDD 40 shares the content key based on the session key shared with the terminal apparatus 30, and decrypts the re-encrypted content information by using the content key. Here, if the content information is stored in the storage unit 41 without being encrypted, there is concern that the content information may be stolen. Thus, the HDD 40 encrypts the content information with an encryption key generated by the random number generator of the HDD 40, and accumulates the encrypted content information in the storage unit 41. The HDD 40 preserves the encryption key in a secret location on the HDD 40, and decrypts the content information accumulated in the storage unit 41 by using the encryption key preserved in the secret location in a case where the content information is watched.

For example, in a case where the terminal apparatus 30 receives a content watching request, the terminal apparatus 30 securely receives the content information from the HDD 40 in accordance with a protocol of the DTCP-IP security layer, and displays the content information.

Here, in a case where the processes are performed in accordance with protocols of the DRM layer, the DTCP-IP security layer, and the like, secret information may be leaked if process contents such as generation of keys and random numbers is leaked and falsified. In order to solve the problem, for example, application programs, Ethernet related programs, TCP/IP programs, DTCP-IP programs, and DRM programs installed in the terminal apparatus 30 are obfuscated, and thus leakage of secret information is suppressed. The obfuscation is to intentionally make a program considerably complex and thus to make program analysis which is a hacking prerequisite considerably complex.

However, there may be a problem in that secret information may not be processed by efficiently and safely switching between security methods.

For example, leakage of secret information is suppressed by obfuscating various programs, but even the obfuscated secret information may be analyzed with a sufficient time, and may thus be peeped or falsified.

The main CPU 32 of the terminal apparatus 30 reads each security program, and processes secret information. For example, since the main CPU 32 of the terminal apparatus 30 can be externally operated, in a case where the main CPU 32 is illegally operated, secret information may be leaked when the security program is executed.

There may be a method in which each existing security protocol is discarded, and new protocols with high security strength are proposed, but the above-described various security protocols have been already widely used, and thus it is difficult to introduce new protocols.

A security apparatus and a control method capable of processing secret information by efficiently and safely switching between security methods may be provided.

Hereinafter, embodiments of a security apparatus and a control method disclosed in the present application will be described in detail with reference to the drawings. The disclosure is not limited to the embodiments.

### Embodiment

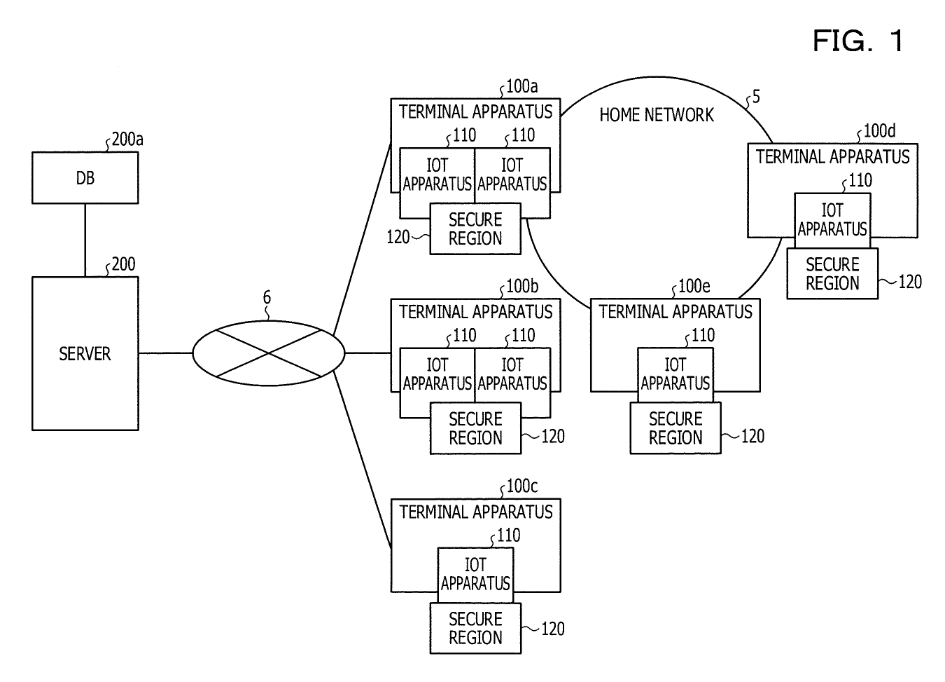

FIG. 1 is a diagram illustrating an example of a network system according to the present embodiment. As illustrated in FIG. 1, the network system includes terminal apparatuses 100a, 100b, 100c, 100d, and 100e, and a server 200. The terminal apparatuses 100a to 100c and the server 200 are connected to each other via an Internet network 6. The server 200 is connected to a DB 200a. The terminal apparatuses 100a, 100d, and 100e are connected to each other via a home network 5.

Each of the terminal apparatuses 100a to 100e corresponds to a personal computer (PC), a mobile phone, a smart phone, a sensor, an IoT apparatus, or the like. In the following description, the terminal apparatuses 100a to 100e are collectively terminal apparatuses 100 as appropriate. Each of the terminal apparatuses 100 includes a single or a plurality of IoT apparatuses 110. The terminal apparatus 100 has a secure region 120. The secure region 120 is a tampering-resistant region, and it is hard to peep or falsify hardware or software included in the secure region 120. The secure region 120 corresponds to a security apparatus.

The terminal apparatus 100 requests a CPU included in the secure region 120 to perform only a process related to security in a case of performing data communication with the server 10 or other terminal apparatuses based on an existing protocol stack. For example, the CPU included in the secure region 120 performs processes of protocols defined in the security CAS layer, the DTCP-IP security layer, the DRM layer, the authentication layer, and the TLS layer independently from a CPU not included in the secure region 120.

The server 200 receives various pieces of information from the terminal apparatus 100, and registers the information in the DB 200a. The server 200 transmits the information stored in the DB 200a to the terminal apparatus 100 which is a request source in response to a request from the terminal apparatus 100. In the present embodiment, as an example, a description will be made of a case where the server 200 transmits content information to the terminal apparatus 100.

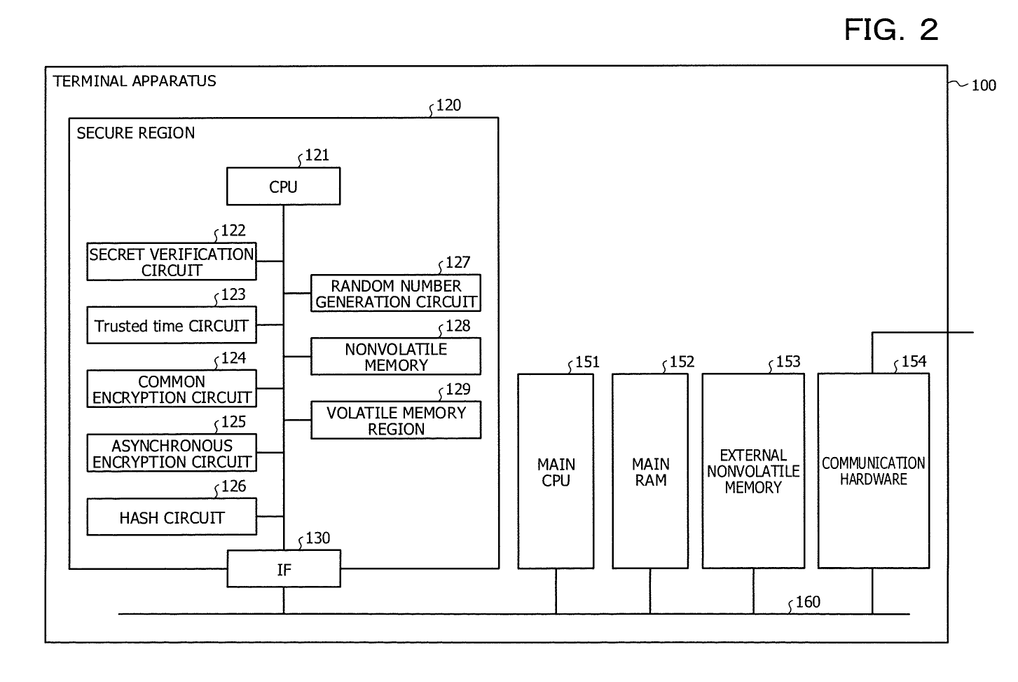

FIG. 2 is a functional block diagram illustrating a configuration of the terminal apparatus according to the present embodiment. As illustrated in FIG. 2, the terminal apparatus 100 includes the secure region 120, a main CPU 151, a main RAM 152, an external nonvolatile memory 153, and communication hardware 154. The respective devices 120, 151, 152, 153, and 154 are connected to each other via a bus 160.

The secure region 120 includes a CPU 121, a secret verification circuit 122, a trusted time circuit 123, a common encryption circuit 124, an asynchronous encryption circuit 125, a hash circuit 126, a random number generation circuit 127, a nonvolatile memory 128, and a volatile memory region 129.

The CPU 121 is a device which reads various programs stored in the nonvolatile memory 128 to the volatile memory region 129 and performs various processes. The CPU 121 receives a command from the main CPU 151 via an IF 130, and executes a program corresponding to the command. Commands received by the CPU 121 from the main CPU are defined by a manager. In a case where a command not defined is received, the CPU 121 performs a process such as erasing the received command such that the command not defined is not executed. Processes performed by the CPU 121 will be described later in detail.

The secret verification circuit 122 is an interface which allows information to be input via the secret verification circuit 122 in a case where a secret input signal determined by the manager or the like in advance is received. For example, during initial setting, the secret verification circuit 122 receives input of a secure region identification number and a master key, and stores information regarding the received secure region identification number and master key in the nonvolatile memory 128. The secure region identification number is information for uniquely identifying the secure region 120, and is a unique number. The master key is a key used to encrypt various pieces of information, and is a unique key.

During initial setting, the secret verification circuit 122 receives information regarding a minimum program group selected in advance by the manager, and stores the received information regarding the program group in the nonvolatile memory 128. For example, the minimum program group includes a download routine, a program accumulation routine, and an accumulated program management data creation routine.

The download routine is a program which defines a procedure of downloading a new program after shipment. The program accumulation routine is a program which defines a procedure of a program downloaded from an external apparatus in the nonvolatile memory 128.

The accumulated program management data creation routine is a program which defines a procedure of reading each program or routine stored in the nonvolatile memory 128. For example, the CPU 121 reads and executes the accumulated program management data creation routine, and generates accumulated program management data, in a case where the program stored in the nonvolatile memory 128 is updated, or a new program is stored in the nonvolatile memory 128. The CPU 121 stores the accumulated program management data in the nonvolatile memory 128.

A name and a version number of a program or a routine accumulated in the nonvolatile memory 128, the capacity of the nonvolatile memory 128 used to execute the program, and a location of a data region in the nonvolatile memory 128 are written in the accumulated program management data. Various pieces of key information and certificates, and various pieces of log information, personal information, and hash values are written in the data region.

Herein, an example is described in which the minimum program group is stored in the nonvolatile memory 128 via the secret verification circuit 122, but the minimum program group may be stored in the nonvolatile memory 128 in advance in the process of manufacturing the secure region 120.

The trusted time circuit 123 is a timer measuring time independently in the secure region 120. For example, the trusted time circuit 123 outputs time information to the CPU 121 in response to a request from the CPU 121. The trusted time circuit 123 accesses the main CPU 151 and acquires time information at a time point at which power is supplied to the secure region 120, and updates time information of the trusted time circuit 123.

The common encryption circuit 124 is a circuit which performs encryption or decryption of information based on an encryption method using a common key in response to a request from the CPU 121. The encryption method using a common key corresponds to, for example, Advanced Encryption Standard (AES), Data Encryption Standard (DES), or 3-DES.

The asynchronous encryption circuit 125 is a circuit which performs encryption or decryption of information based on an asynchronous key encryption method using a public key and a secret key in response to a request from the CPU 121. The asynchronous key encryption method corresponds to, for example, Rivest Shamir Adleman (RSA) or an elliptic cipher.

In a case where input of information is received from the CPU 121, the hash circuit 126 is a circuit which computes a hash value of the information, and notifies the CPU 121 of the hash value.

The random number generation circuit 127 is a circuit which generates a random number in response to a request from the CPU 121.

The nonvolatile memory 128 is a storage device which stores a secure region identification number, a master key, and a minimum program group. The CPU 121 accumulates various program groups downloaded by executing the download routine in the nonvolatile memory 128 in accordance with the program accumulation routine.

For example, a program group accumulated in the nonvolatile memory 128 includes a plurality of types of security programs for executing a security process with an external apparatus in accordance with a predetermined security method. The external apparatus corresponds to the server 200 connected to the terminal apparatus 100 via the Internet network 6 or another terminal apparatus 100 connected to the terminal apparatus 100 via the home network 5. The predetermined security method is a method based on protocols defined in, for example, the security CAS layer, the DTCP-IP security layer, the DRM layer, the authentication layer, and the TLS layer.

The security program has a function of performing mutual authentication with an external apparatus, a function of generating a session key and sharing the session key with the external apparatus, and a function of encrypting data.

For example, in a case where the security program is a “security program A” using a security method based on a protocol defined in the DRM layer, the security program has the following functions. The security program A has a function of performing mutual authentication with the server 200 by using a pair of a public key and a secret key. The security program A has a function of generating a session key. The security program A has a function of receiving a content key A from the server 200. For example, content information received from the server 200 is encrypted with the content key A.

For example, in a case where the security program is a “security program B” using a security method based on a protocol defined in the DTCP-IP security layer, the security program has the following functions. The security program B has a function of performing mutual authentication with an external apparatus connected to the home network 5 by using a pair of a public key and a secret key. The security program B has a function of generating a session key by using the random number generation circuit 127 and sharing the session key with an external apparatus. The security program B has a function of generating a content key B by using the session key.

The security program B has, for example, a function of decrypting content information by using the content key A used by another security program (security program A). The security program B has a function of re-encrypting content information which is decrypted by using the content key A, by using the content key B.

The security programs A and B have been described for convenience of the description herein, but other security programs may be accumulated in the nonvolatile memory 128. For example, security programs based on protocols defined in the TLS layer, the security CAS layer, and the authentication layer are accumulated in the nonvolatile memory 128.

In addition to the program groups, a hash value of each program group is stored in correlation with information for identifying a program in the nonvolatile memory 128. The hash value is computed by the hash circuit 126.

Some of the program groups stored in the nonvolatile memory 128 may be stored in the external nonvolatile memory 153. For example, the CPU 121 encrypts some of the program groups stored in the nonvolatile memory 128 with a master key, outputs the program groups to the main CPU 151, and requests the external nonvolatile memory 153 to store the program groups. In a case where a program in the external nonvolatile memory 153 is used, the CPU 121 requests the main CPU 151 to acquire an encrypted program in the external nonvolatile memory 153, and decrypts the program with a master key. In a case where a hash value of the program decrypted with the master key matches a hash value of the nonvolatile memory, the CPU 121 executes the decrypted program.

The nonvolatile memory 128 stores performance information of the secure region 120. The performance information includes a processing speed of the CPU 121, a processing bit number of the CPU 121, a supported encryption method, the presence or absence of the random number generation circuit 127, the presence or absence of the hash circuit 126, and information regarding the type of hash calculation performed by the hash circuit 126. The performance information includes secure degree information of the secure region 120, a memory capacity of the volatile memory region 129, an unused capacity of the volatile memory region 129, the use or non-use of the external nonvolatile memory 153, and information regarding a memory capacity of the external nonvolatile memory 153 permitted by the secure region 120. The performance information includes whether or not a clock of the trusted time circuit 123 is supported, the type of OS installed in the secure region 120, and grade information of the secure region 120.

The secure degree information included in the performance information is information indicating the degree to which the secure region 120 is logically and physically secure. For example, a logical secure degree is specified by the type of command or the like received by the CPU 121 from the main CPU 151 or the like. For example, as the number of commands received by the CPU 121 becomes larger, the logical secure degree is reduced.

Regarding a secure degree, for example, in a case where the main CPU 151 and the CPU 121 are physically regarded as the same CPU, and the CPU operates as the main CPU, a normal mode may be set, and, in a case where the CPU operates as the CPU 121, a secure mode may be set. In a case where the CPU operates in the secure mode, the CPU can access all memory regions including a secure memory region, and, in a case where the CPU operates in the normal mode, the CPU may not access the secure memory region. In this case, the CPU is the same physically, but is differentiated logically. In a case where CPUs are physically different from each other, the secure degree is naturally improved. The secure degree may be defined depending on CPUs which are physically different from each other or CPUs which are merely logically different from each other. An existing CPU employing such an architecture is an ARM processor or the like. The ARM processor has a normal mode and a trusted mode, and can access whole memory spaces in the trusted mode, but is restricted in a memory space which can be accessed in the normal mode. The ARM processor operates while switching between the modes.

The physical secure degree is specified through tests regarding electromagnetic wave analysis and power analysis attack. For example, a manager of a factory manufacturing the secure region 120 generates secure degree information set in the secure region 120 by taking into consideration both of a logical secure degree and a physical secure degree, and stores the secure degree information in the nonvolatile memory 128.

The manager may determine a grade of the secure region 120 based on elements other than a grade included in the performance information, and may store the grade in the nonvolatile memory 128.

The volatile memory region 129 is a region to which the CPU 121 the reads the program stored in the nonvolatile memory 128 and executes the program. The volatile memory region is a region in which information used for the CPU 121 to perform a process is temporarily stored.

The IF 130 is an interface which relays information transmitted and received between the CPU 121 in the secure region 120 and the main CPU 151 out of the secure region 120.

The main CPU 151 is a processor which executes a program stored in the main RAM 152 so as to execute various pieces of information. For example, the main CPU 151 performs connection to the server 10 via the Internet network 6 and connection to other terminal apparatuses 100 via the home network 5 based on protocols of the Ethernet layer, the IP layer, the TCP/UDP layer, and the HTTP layer.

The main CPU 151 requests the CPU 121 in the secure region 120 to perform processes based on protocols of the security CAS layer, the DTCP-IP security layer, the DRM layer, the authentication layer, and the TLS layer. The main CPU 151 relays encryption information which the CPU 121 exchanges with the server 10 via the Internet network 6. The main CPU 151 relays encryption information which the CPU 121 exchanges with other terminal apparatuses 100 via the home network 5.

In a case where a request for reading information stored in the external nonvolatile memory 153 is received from the CPU 121 in the secure region 120, the main CPU 151 reads target information from the external nonvolatile memory 153, and outputs the read information to the CPU 121.

The main RAM 152 stores, for example, an Ethernet processing program, an IP processing program, a TCP/UDP processing program, and an HTTP processing program. The Ethernet processing program is a program which is executed based on a protocol of the Ethernet layer. The IP processing program which is executed based on a protocol of the IP layer. The TCP/UDP processing program which is executed based on a protocol of the TCP layer or the UDP layer. The HTTP processing program which is executed based on a protocol of the HTTP layer.

For example, some of the program groups in the nonvolatile memory 128 are stored in the external nonvolatile memory 153 in an encrypted state. The Ethernet processing program, the IP processing program, the TCP/UDP processing program, and the HTTP processing program may be stored.

The communication hardware 154 receives data from an external apparatus via the home network 5 and the Internet network 6, and outputs the received information to the main CPU 151. The communication hardware 154 outputs data which is requested to be transmitted from the main CPU 151 to an external apparatus via the home network 5 and the Internet network 6. The communication hardware 154 receives information a broadcasting station (not illustrated) via a broadcast network, and outputs the received information to the main CPU 151.

Next, a description will be made of an example of a process performed by the CPU 121 in a case where power is supplied to the secure region 120. As an example, it is assumed that a management data call routine, a program selection and activation routine, a program stop routine, and an external communication routine for the secure region are stored in the nonvolatile memory 128. The CPU 121 executes the download routine, the program accumulation routine, and the like, so as to store the programs in the nonvolatile memory 128.

If power is supplied to the secure region 120, the CPU 121 activates the management data call routine from the nonvolatile memory 128, and reads data related to a program or a routine group managed by the secure region 120 from the nonvolatile memory 128. For example, the CPU 121 activates the program selection and activation routine, selects a predetermined program or routine based on the read data, and activates the selected program or routine.

If it is detected that a program is not used, the CPU 121 activates the program stop routine, and stops the program which is not used. The CPU 121 releases the volatile memory region 129 which is used by the program which is not used.

Among programs activated by the CPU 121, there is a program cooperating with the main CPU 151 out of the secure region 120. For example, the external communication routine for the secure region is a program cooperating with the main CPU 151. The CPU 121 activates the external communication routine for the secure region so as to transmit and receive information to and from the main CPU 151. In order to suppress the CPU 121 from performing an illegal process such as information leakage, the external communication routine for the secure region defines in advance the type of command to be received from the main CPU 151.

For example, in a case where the CPU 121 activates the program accumulation routine so as to accumulate a program or data in the external nonvolatile memory 153, the CPU requests the main CPU 151 to accumulate a program or data in accordance with the external communication routine for the secure region. In a case where the CPU 121 activates other programs in the secure region 120 and gives various requests to the main CPU 151, the CPU gives the requests in accordance with the external communication routine for the secure region.

The external communication routine for the secure region also defines a procedure executed in a case where the CPU 121 receives a command from the main CPU 151. For example, commands received by the CPU 121 from the main CPU 151 include a specific program download command, a secure region identification number call command, and a command for reading performance information of the secure region 120.

Next, a description will be made of examples of a process in which the terminal apparatus 100 receives content information from the server 200 by using the secure region 120, and a process in which the terminal apparatus accumulates the content information in an HDD connected to the home network 5.

In a case where the terminal apparatus 100 receives a command for watching the specific content from a user, the main CPU 151 is connected to the server 200 via the Internet network 6. For example, the main CPU 151 performs the following processes in a case of being connected to the server 200. The main CPU 151 generates a TCP packet, buries the TCP packet in an IP packet, and buries the IP packet in an Ethernet packet. The main CPU 151 executes the TCP program, the IP program, and the Ethernet program so as to be connected to the server 200.

If connection to the server 200 is completed, the main CPU 151 requests the secure region 120 to perform a process corresponding to the DRM layer. In a case where the request for the process corresponding to the DRM layer is received, the CPU 121 in the secure region 120 reads the security program A from the nonvolatile memory 128.

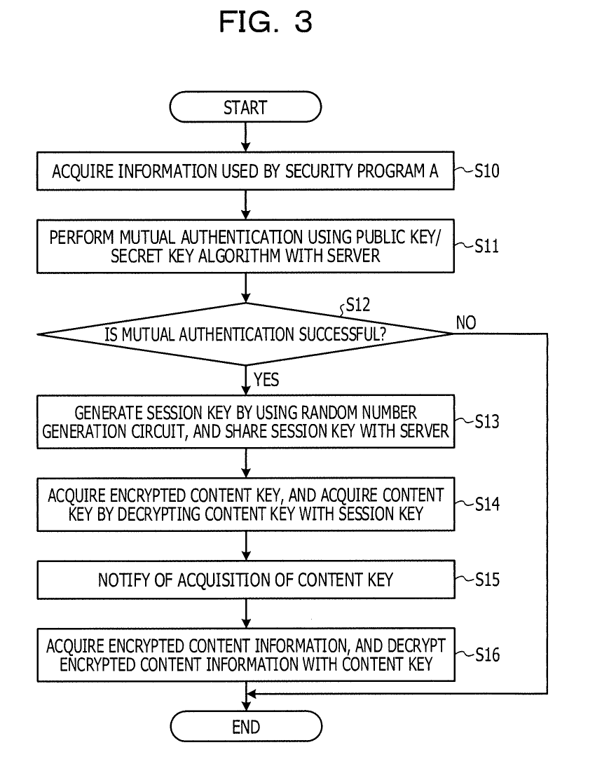

The CPU 121 having activated the security program A performs the following DRM process. FIG. 3 is a flowchart illustrating an example of the DRM process performed by the CPU in the secure region. As illustrated in FIG. 3, the CPU 121 in the secure region 120 acquires information used by the security program A (step S10). For example, the information used by the security program A includes a DRMID, a DRM certificate, a public key and a secret key of the secure region 120, a public key of the server 200, and a DRMID of a DRM operating in the server 200.

The CPU 121 performs mutual authentication using a public key/secret key algorithm with the server 200 (step S11). For example, the CPU 121 generates a random number by using the random number generation circuit 127 when the mutual authentication is performed. The CPU 121 starts authentication with the server 200 by using the random number, the DRMID, and the pair of public key and secret key. The server 200 makes a response by using a random number, a DRMID, and a pair of a public key and a secret key of the server 200.

The CPU 121 determines whether or not the mutual authentication with the server 200 is successful (step S12). In a case where the mutual authentication with the server 200 fails (No in step S12), the CPU 121 finishes the process. For example, the CPU 121 outputs an error to the main CPU 151.

In a case where the mutual authentication with the server 200 is successful (Yes in step S12), the CPU 121 proceeds to step S13. The CPU 121 generates a session key by using the random number generation circuit 127, and shares the session key with the server 200 (step S13).

The CPU 121 acquires the content key A encrypted with the session key from the server 200, and decrypts the content key A with the session key so as to acquire the content key A (step S14).

The CPU 121 notifies the main CPU 151 that the content key A has been acquired (step S15). If the notification that the content key A has been acquired is received, the main CPU 151 requests the server 200 to transmit content information. In a case where the request for transmitting the content is received, the server 200 encrypts the content information with the content key A, and transmits the content information to the terminal apparatus 100. For example, the content information is MPEG-compressed in a Real-time Transport Protocol (RTP) packet, and is transmitted to the terminal apparatus 100. The main CPU 151 outputs the encrypted content information to the CPU 121.

The CPU 121 acquires the encrypted content information, and decrypts the content information with the content key A (step S16). In step S16, the CPU 121 may notify the main CPU 151 of information regarding the content key A, and may request the main CPU 151 to decrypt the encrypted content information.

As described above, the CPU 121 in the secure region 120 performs the DRM process illustrated in FIG. 3, so as to perform mutual authentication with the server 200, generation and sharing of the session key, acquisition of the content key A, and decryption of the content information.

Next, after the DRM process in FIG. 3 is performed, the CPU 121 in the secure region 120 reads the security program B from the nonvolatile memory 128, and activates the security program B. The CPU 121 having activated the security program B performs the following DTCP-IP process.

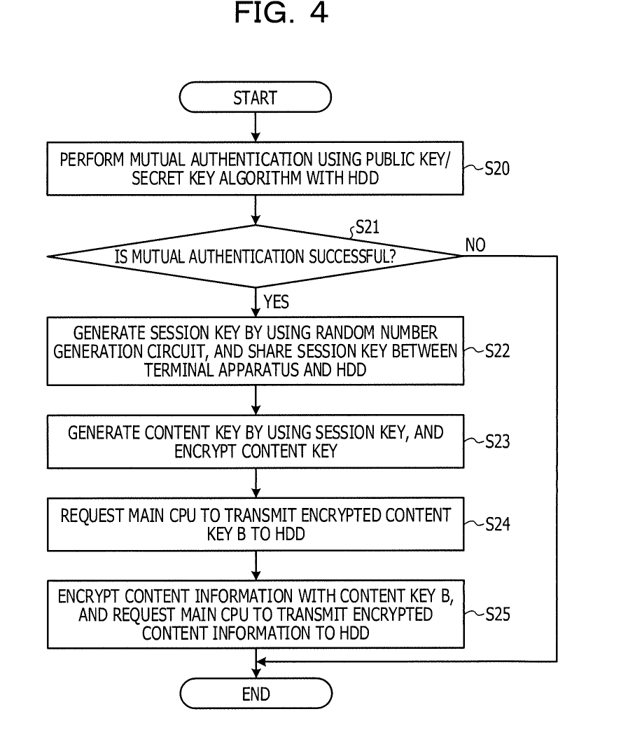

FIG. 4 is a flowchart illustrating an example of the DTCP-IP process performed by the CPU in the secure region. In FIG. 4, as an example, a description will be made of a case where the terminal apparatus 100 accumulates content information received from the server 200 in an HDD connected to the home network 5. For example, the HDD is the HDD 40 illustrated in FIG. 10.

As illustrated in FIG. 4, the CPU 121 in the secure region 120 performs mutual authentication using a public key/secret key algorithm with the HDD 40 (step S20).

The CPU 121 determines whether or not the mutual authentication with the HDD 40 is successful (step S21). In a case where the mutual authentication with the HDD 40 fails (No in step S21), the CPU 121 finishes the process. For example, the CPU 121 outputs an error to the main CPU 151.

In a case where the mutual authentication with the HDD 40 is successful (Yes in step S21), the CPU 121 proceeds to step S22. The CPU 121 generates a session key by using the random number generation circuit 127, and shares the session key with the HDD 40 (step S22).

The CPU 121 generates the content key B by using the session key, and encrypts the content key B (step S23). The CPU 121 requests the main CPU 151 to transmit the content key B to the HDD (step S24).

The CPU 121 encrypts the content information, which is decrypted with the content key A through the DRM process, by using the content key B, and requests the main CPU 151 to transmit the encrypted content information to the HDD 40 (step S25). In step S26, the CPU 121 may notify the main CPU 151 of information regarding the content key B, and may request the main CPU 151 to encrypt the content information. The main CPU 151 encrypts the content information based on the content key, and transmits the encrypted content information to the HDD.

Next, a description will be made of a process in a case where a new program is downloaded to the secure region 120. A downloaded new program corresponds to, for example, the security program A or the security program B. Hereinafter, as an example, a description will be made of a process in a case where the security program A is downloaded.

The CPU 121 in the secure region 120 receives a download command for the security program A from the main CPU 151. The CPU 121 checks if there is a download routine in accordance with a management data reading routine stored in the nonvolatile memory 128. The CPU 121 checks a location of a process code or related information. The CPU 121 reads the download routine to the volatile memory region 129 in accordance with the program accumulation routine. In a case where the download routine is read to the volatile memory region 129, the CPU 121 computes a hash value of the download routine, compares a hash value calculated in advance therewith, and checks whether or not the download routine is falsified. In a case where the download routine is falsified, download is stopped.

In a case where the download is not falsified, the CPU 121 activates the download routine, and is connected to the server 200 by using the related information. The related information includes a download program identification number, a pair of a public key and a secret key, a public key of the server 200, and Uniform Resource Locator (URL) of the server 200. The CPU 121 is connected to the server 200 via the main CPU 151. The main CPU 151 is connected to the server 200 in accordance with protocols of the existing Ethernet layer, the IP layer, and the TCP layer.

In a case where the CPU 121 which is activating the download routine is connected to the server 200, mutual authentication is performed with the server 200 by using the mutual pairs of public keys and secret keys. The CPU 121 generates a random number by using the random number generation circuit 127 so as to generate a session key, and shares the session key with the server 200. The CPU 121 receives a content key encrypted with the session key from the server 200, and acquires the content key by using the session key.

The CPU 121 which is activating the download routine acquires the security program A encrypted with the content key and related information of the security program A from the server 200. The CPU 121 decrypts the encrypted information with the content key. The CPU 121 activates the program accumulation routine, and accumulates the decrypted security program A and related information in the nonvolatile memory 128. The CPU 121 computes hash values of the security program A and the related information, and stores the hash values in the nonvolatile memory 128 in correlation with the security program A. The CPU 121 writes a version number of the security program A, a capacity of the volatile memory region 129 used for an operation, and a location of a data region of the nonvolatile memory 128 into the accumulated program management data.

If the download is finished, the CPU 121 which is activating the download routine reports finish of download to the main CPU 151. If the finish report is received, the main CPU 151 outputs a download routine stop command to the CPU 121. If the stop command is received, the CPU 121 stops the download routine, and outputs a stop report to the main CPU 151.

Meanwhile, in a case where the CPU 121 which is activating the download routine receives a request for performance information from the server 200, the CPU 121 encrypts the performance information with the content key, and notifies the server 200 of the encrypted performance information. For example, the server 200 has reference performance information which causes the security program A to be executed. The server 200 compares the performance information with the reference performance information, and, in a case where the performance information of the secure region 120 is higher than the reference performance information, the security program A is encrypted with the content key, and encrypted content information is transmitted to the CPU 121. In contrast, in a case where the performance information of the secure region 120 is not higher than the reference performance information, the server 200 notifies the CPU 121 of information indicating that there is no performance of executing the security program A. In a case where the information indicating that there is no performance of executing the security program A is received, the CPU 121 notifies the main CPU 151 of information indicating that download fails.

Here, the server 200 may have a plurality of security programs A1, A2, and A3 for which reference performance information differs, select a security program which can be executed with the performance information of the secure region 120, and transmit the selected security program. For example, it is assumed that the performance information of the secure region 120 is higher than reference performance information for the security program A1. In this case, the server 200 encrypts the security program A1 with the content key, and transmits the encrypted security program to the CPU 121.

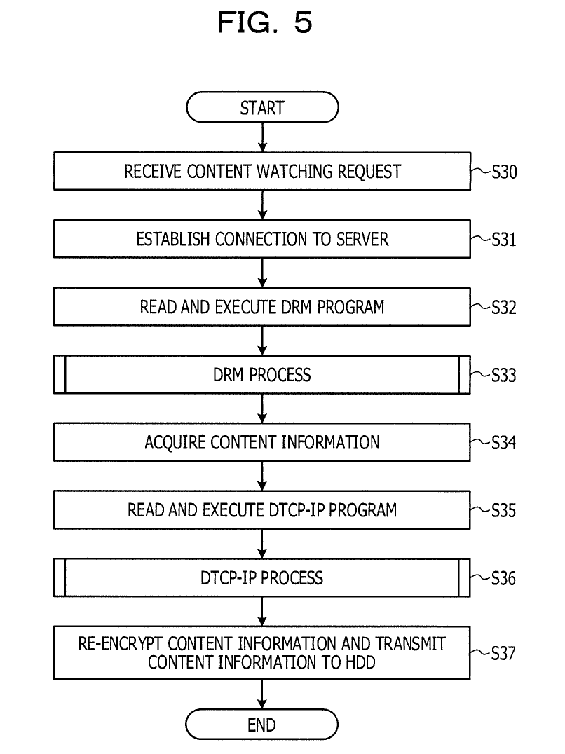

Next, a description will be made of a process procedure performed in a case where the secure region 120 according to the present embodiment receives a content watching request. FIG. 5 is a flowchart illustrating a process procedure performed in a case where the secure region receives a content watching request.

As illustrated in FIG. 5, the CPU 121 in the secure region 120 receives a request for watching content information from the main CPU 151 (step S30). The CPU 121 establishes connection to the server 200 via the main CPU 151 (step S31).

The CPU 121 reads and executes the security program A (DRM program) (step S32). The CPU 121 performs a DRM process (step S33). The DRM process in step S33 corresponds to the process illustrated in FIG. 3.

The CPU 121 decrypts the encrypted content information by using the content key A, and acquires the content information (step S34). The process in step S34 may be performed by the main CPU 151 instead of the CPU 121. In a case where the main CPU 151 performs the process, the main CPU 151 acquires the content key A from the CPU 121, and decrypts the content information encrypted by the server 200, by using the content key A.

The CPU 121 reads and executes the program B (DTCP-IP program) (step S35). The CPU 121 performs a DTCP-IP process (step S36). The DTCP-IP process in step S36 corresponds to the process illustrated in FIG. 4.

The CPU 121 re-encrypts the content information which is decrypted with the content key A, by using the content key B, and transmits the content information to the HDD (step S37). The process in step S37 may be performed by the main CPU 151 instead of the CPU 121. In a case where the main CPU 151 performs the process, the main CPU 151 acquires the content key B from the CPU 121, and encrypts the content information by using the content key B.

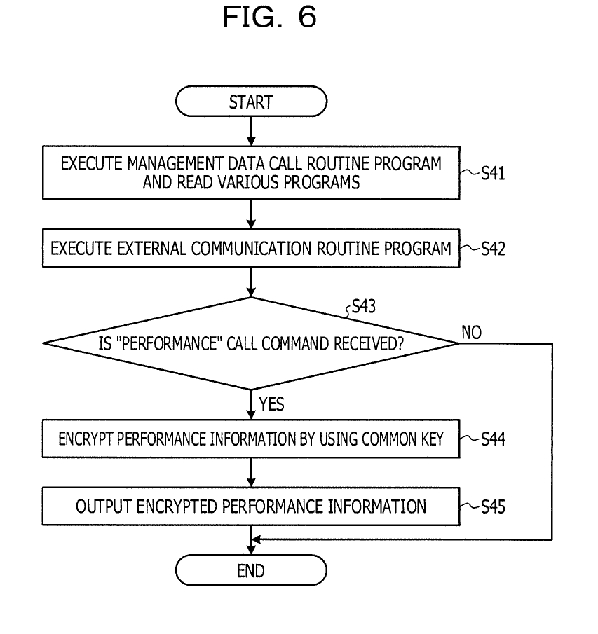

Next, a description will be made of an example of a process procedure performed in a case where the CPU 121 in the secure region 120 receives a request for performance information. FIG. 6 is a flowchart illustrating a process procedure performed in a case where a request for performance information is received. As illustrated in FIG. 6, the CPU 121 executes the management data call routine, and reads various programs (step S41).

The CPU 121 performs the external communication routine (step S42). The CPU 121 determines whether or not a performance information call command is received (step S43). In a case where a performance information reading command is not received (No in step S43), the CPU 121 finishes the process.

On the other hand, in a case where the performance information reading command is received (Yes in step S43), the CPU 121 encrypts the performance information by using a common key (step S44). For example, the CPU 121 shares the content key with the server 200 in accordance with the security program A, and encrypts the performance information by using the content key A (common key) in a case where there is a request for the performance information from the server 200. The CPU 121 outputs the encrypted performance information (step S45).

Meanwhile, in the above description, a description has been made of a case where the CPU 121 in the secure region 120 performs mutual authentication using “public key and secret key”, sharing of a temporary key (content key), and encryption of data when the security program A is executed. However, the same process may be performed by using a “common key”. This case is based on the secure region 120 and the server 200 sharing a common key.

A description will be made of mutual authentication performed by the CPU 121 in the secure region 120 with the server 200. First, a description will be made of a process in which the CPU 121 authenticates the server 200. The CPU 121 generates a random number by using the random number generation circuit 127, encrypts the generated random number, a secure region identification number, and an identification number of the server 200 with the common key, and transmits the encrypted information to the server 200.

The server 200 decrypts the encrypted information received from the CPU 121 by using the common key. The server 200 applies secret calculation known by only the secure region 120 and the server 200 to the random number. The server 200 encrypts the random number to which secret calculation is applied, the secure region identification number, and the identification number of the server 200 by using the common key, and transmits the encrypted information to the CPU 121.

The CPU 121 decrypts the encrypted information received from the server 200 by using the common key. In a case where it is determined that the random number to which secret calculation is applied is a correct random number, the CPU 121 authenticates the server 200.

Next, a description will be made of a process in which the server 200 authenticates the CPU 121. The server 200 generates a random number by using the random number generation circuit of the server 200, encrypts the generated random number, a secure region identification number, and an identification number of the server 200 with the common key, and transmits the encrypted information to the secure region 120.

The CPU 121 decrypts the encrypted information received from the server 200 by using the common key. The CPU 121 applies secret calculation known by only the secure region 120 and the server 200 to the random number. The CPU 121 encrypts the random number to which secret calculation is applied, the secure region identification number, and the identification number of the server 200 by using the common key, and transmits the encrypted information to the server 200.

The server 200 decrypts the encrypted information received from the secure region 120 by using the common key. In a case where it is determined that the random number to which secret calculation is applied is a correct random number, the server 200 authenticates the secure region 120.

Next, a description will be made of a process in which the CPU 121 in the secure region 120 shares a temporary key with the server 200. After the CPU 121 and the server 200 succeed in mutual authentication, a temporary key generated by using a random number is encrypted with a secret shared key, and is transmitted to the server 200. The server 200 decrypts the encrypted temporary key with the secret shared key. Such a process is performed, and thus the temporary key can be shared between the CPU 121 and the server 200. For example, the server 200 encrypts content information by using the temporary key, and transmits the content information to the secure region 120. The CPU 121 in the secure region 120 decrypts the encrypted content information by using the temporary key.

Next, a description will be made of effects of the secure region 120 according to the present embodiment. The CPU 121 and the nonvolatile memory 128 are provided in the secure region 120 in which falsification or peeping is hard, and a plurality of programs having different security methods are accumulated in the nonvolatile memory 128. The CPU 121 executes security programs accumulated in the nonvolatile memory 128, takes over secret information obtained by a certain security program to another security program, and performs a process. Consequently, it is possible to process secret information by efficiently and safely switching between security methods.

For example, the CPU 121 in the secure region 120 executes the security program A, securely receives encrypted content information (corresponding to secret information) from the server 200, and decrypts the content information by using the content key A. The CPU 121 executes the security program B, encrypts the content information by using the content key B, and transmits the content information to the HDD. Thus, regarding processing of secret information, secret information which is processed inside the secure region 120 and is output to the outside is encrypted. Therefore, secret information can be processed without a content of the secret information being leaked to the outside.

The secure region 120 has a plurality of security programs, and the CPU 121 receives selection of a security program from the main CPU 151, and executes the selected security program. Thus, the main CPU 151 can entrust the secure region 120 with a security process fitted to an external apparatus which is a connection destination. The respective security programs employ methods based on protocols defined in the existing security CAS layer, DTCP-IP security layer, DRM layer, authentication layer, and TLS layer, and thus secret information can be securely processed without providing a special program or hardware in an existing IoT apparatus.

In a case where performance information is stored in the nonvolatile memory 128, and various programs are downloaded or updated, the secure region 120 notifies the server 200 of the performance information in response to a request from an external apparatus such as the server 200. In a case where a download target program is suitable for the performance information based on the performance information, the server 200 transmits the program to the secure region 120. Thus, the secure region 120 can download a program suitable for performance, and can thus appropriately execute the program.

### REFERENCE SIGNS LIST

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A security apparatus comprising:
a memory provided in a secure region and configured to store a plurality of programs which preforms respective security processes with an external apparatus in accordance with respective security methods, and security information which is used for the security processes; and
a processor configured to:
execute a first program among the plurality of programs;
perform a first security process with a first external apparatus;
acquire first secret information from the first external apparatus;
execute a second program different from the first program among the plurality of programs;
perform a second security process with a second external apparatus; and
convert the first secret information into second secret information to be transmitted to the second external apparatus.

2. The security apparatus according to claim 1, wherein
the memory stores secure degree information indicating a degree with which the security apparatus is logically and physically secure, and
the processor outputs the secure degree information to the external apparatus in a case where a request for the secure degree information is received.

3. The security apparatus according to claim 1,
wherein the first security information is information which is used to perform mutual authentication with the external apparatus, and the security processes include a mutual authentication process between the external apparatus and the security apparatus, a process which generates a session key, and a process which generates a content key to decrypt and encrypt the secret information.

4. The security apparatus according to claim 1, further comprising:
an external memory located outside the secure region, wherein
the memory stores a unique master key, and
the processor encrypts some or all of the plurality of programs by using the master key, and stores the encrypted programs in the external memory.

5. The security apparatus according to claim 1, wherein
the memory stores information regarding performance of the processor and the memory, and
the processor encrypts and outputs the information regarding performance in a case where an inquiry about the performance is received.

6. A security apparatus comprising:
a memory provided in a secure region and configured to store secure degree information indicating a degree with which the security apparatus is logically and physically secure; and
a processor configured to:
output the secure degree information to an external apparatus in a case where a request for the secure degree information is received from the external apparatus.

7. The security apparatus according to claim 6, wherein the memory is configured to store a plurality of programs which preforms respective security processes with the external apparatus in accordance with respective security methods, and security information which is used for the security processes; and
a processor configured to:
execute a first program among the plurality of programs;
perform a first security process with a first external apparatus;
acquire first secret information from the first external apparatus;
execute a second program different from the first program among the plurality of programs;
perform a second security process with a second external apparatus; and
convert the first secret information into second secret information to be transmitted to the second external apparatus.

8. The security apparatus according to claim 7,
wherein the first security information is information which is used to perform mutual authentication with the external apparatus, and the security processes include a mutual authentication process between the external apparatus and the security apparatus, a process which generates a session key, and a process which generates a content key to decrypt and encrypt the secret information.

9. The security apparatus according to claim 7, further comprising:
an external memory located outside the secure region, wherein
the memory stores a unique master key, and
the processor encrypts some or all of the plurality of programs by using the master key, and stores the encrypted programs in the external memory.

10. The security apparatus according to claim 7, wherein
the memory stores information regarding performance of the processor and the memory, and
the processor encrypts and outputs the information regarding performance in a case where an inquiry about the performance is received.

11. A control method comprising:
executing, by a computer including a processor provided in a secure region and a memory provided in the secure region and configured to store a plurality of programs which perform respective security processes with an external apparatus in accordance with respective security methods and security information which is used for the security processes, a first program among the plurality of programs and perform a first security process with a first external apparatus;
acquiring first secret information from the first external apparatus;
executing a second program different from the first program among the plurality of programs;
performing a second security process with a second external apparatus; and
converting the first secret information into secret second information to be transmitted to the second external apparatus.

12. The control method according to claim 11, wherein
the memory stores secure degree information indicating a degree with which the security apparatus is logically and physically secure, and
the processor outputs the secure degree information to the external apparatus in a case where a request for the secure degree information is received.

13. The control method according to claim 11, wherein
the first security information is information which is used to perform mutual authentication with the external apparatus, and the security processes include a mutual authentication process between the external apparatus and the security apparatus, a process which generates a session key, and a process which generates a content key to decrypt and encrypt the secret information.

14. The control method according to claim 11, wherein
the memory stores a unique master key, and further comprising:
encrypting some or all of the plurality of programs by using the master key; and
storing the encrypted programs in an external memory which is located outside the secure region.

15. The control method according to claim 11, wherein
the memory stores information regarding performance of the processor and the memory, and further comprising:
encrypting and outputting the information regarding performance in a case where an inquiry about the performance is received.
